(19) United States
(12) Patent Application Publication
(10) Pub. No.: US 2025/0145388 A1
(43) Pub. Date: May 8, 2025

(54) Systems and Methods for PALLETIZING AND DEPALLETIZING

(71) Applicant: Swisslog AG, Buchs (CH)

(72) Inventors: Franz Joller, Affoltern a/A (CH); Roland Meier, Affoltern a/A (CH); Urs Kamm, Affoltern a/A (CH)

(73) Assignee: Swisslog AG, Buchs (CH)

(21) Appl. No.: 18/683,573

(22) PCT Filed: Jul. 27, 2022
(86) PCT No.: PCT/EP2022/071017

§ 371 Date: Mar. 26, 2024

(30) Foreign Application Priority Data
Aug. 19, 2021 (EP) EP 21 192 160.6

(51) Int. Cl. B65G 47/91; B25J 15/00; B25J 15/06; B65G 61/00

(52) U.S. Cl. CPC B65G 47/91; B25J 15/0014; B25J 15/0616; B65G 61/00; B65G 2201/0235

(57) ABSTRACT

A gripper for palletizing and/or depalletizing containers by using of a robot, having a support structure and a blade, which is reversibly adjustable relative to the support structure in a pass-beneath direction in order to support at least one container, in particular a stack of containers, in a supporting direction at right angles to the pass-beneath direction. The gripper includes: a) a punch arrangement having a first punch, which is reversibly adjustable relative to the support structure in the supporting direction; b) a sucker arrangement having a first sucker in order to suck onto a first suction side of the container or stack of containers at right angles to the supporting direction; and/or c) a side jaw arrangement having a first side jaw, which is reversibly adjustable relative to the support structure in a first covering direction; and a second side jaw, which is reversibly adjustable relative to the support structure in a second covering direction at right angles to the first covering direction. A method for palletizing and/or depalletizing one or more containers, said containers includes using a robot system having a gripper as disclosed.

### CROSS-REFERENCE TO RELATED APPLICATIONS

This application is a national phase application under 35 U.S.C. § 371 of International Patent Application No. PCT/EP2022/071017, filed Jul. 27, 2022 (pending), which claims the benefit of priority to European Patent Application No. EP 21 192 160.6, filed Aug. 19, 2021, the disclosures of which are incorporated by reference herein in their entirety.

### TECHNICAL FIELD

The present invention relates to a gripper, a robot system, and a method for palletizing and/or depalletizing containers.

### SUMMARY

The object of the present invention is to improve the palletizing and/or depalletizing of containers.

This object is achieved by a gripper, a robot system with a gripper, and methods as disclosed herein.

According to one embodiment of the present invention, a (robot) gripper which is provided, in particular configured or used, for palletizing and/or depalletizing containers by means of a robot of a robot system, has:
a support structure which, in one embodiment (during palletizing and/or depalletizing), is located on top and/or on the side and which, in one embodiment, is attached to the robot or is configured or used for this purpose, in particular detachably and/or with or on a connection surface (during palletizing and/or depalletizing) located on top or on the side of the support structure; and
a blade which is reversibly adjustable relative to the support structure in a pass-beneath direction which, in one embodiment, is horizontal during palletizing and/or depalletizing, in order to at least partially pass beneath at least one container, in one embodiment a container stack, in the pass-beneath direction, and to support the at least partially passed under container (stack) in a support direction which, in one embodiment, is vertical during palletizing and/or depalletizing, transverse to the pass-beneath direction. In one embodiment, the stack has two or more containers, in particular can consist thereof, arranged one on top of the other in the support direction.

In one embodiment, a lateral (connection surface for) fastening to the robot allows a greater working height-a particularly preferred-upper (connection surface for) fastening to the robot, in one embodiment, a static connection or one which is particularly advantageous in terms of load.

As explained further below, the invention is suitable for the successive, in particular alternating, palletizing and/or depalletizing of containers with different lengths and/or widths, and/or of containers with reusable load carriers, in particular of plastic, metal or the like, and/or containers with non-reusable load carriers, in particular of cardboard, wood, or the like, and is preferably used for this purpose without being limited thereto. In one embodiment, a reusable load carrier made of plastic, metal, or the like is produced, and/or a reusable load carrier and/or one that is more stable than a non-reusable load carrier. A load carrier which cannot be reused is produced in one embodiment from cardboard, wood or the like and/or is a disposable load carrier.

According to one embodiment of the present invention, the gripper further has:

a punch arrangement having a first punch which is reversibly adjustable relative to the support structure in the support direction, in order to press a first side edge of the container or container stack, which in one embodiment (during palletizing and/or depalletizing) is located at the top, opposite the support direction, in particular against an underlying container or an underlying floor surface.
As a result, in one embodiment, the container or the container stack can advantageously be tilted in the direction of an outer side of the container or container stack, and thereby the blade can at least partially pass beneath, or the blade can be moved into the free space under the container (stack) resulting from the tilting. In one embodiment, the container or the container stack is tilted about a lower edge which lies on the same outer side as the first side edge.

This is particularly advantageous for reusable load carriers, since they are stable (more stable than non-reusable load carriers). In one embodiment, the reusable load carriers which are tilted with the aid of the punch arrangement are nested in one another in the vertical direction. In one embodiment, the nesting of the load carriers in one another additionally supports their stability (in the vertical direction). Such a nesting is difficult or not possible with non-reusable load carriers so that the depalletizing, described in more detail below, with tilting of the gripper is particularly preferably used or advantageous for reusable load carriers.

Preferably, the container or the container stack is tilted over or around a lower edge on the side of the first side edge or toward the first side edge. Additionally or alternatively, in one embodiment, the first side edge and/or this lower edge are parallel to the pass-beneath direction.

In one embodiment, the punch arrangement has a second punch which is reversibly adjustable relative to the support structure in the support direction in order to press a second side edge of the container or container stack adjacent to the first side edge, in particular against this angled second side edge of the container or container stack, opposite the support direction, in particular against the underlying container or the underlying floor surface.

As a result, in one embodiment, the container or the container stack can be tilted very advantageously, in particular (more) securely, in the direction of the outside of the container or container stack.

Alternatively or particularly preferably in addition to the punch arrangement, the gripper further has, according to one embodiment of the present invention:
a suction device arrangement having a first suction device, which, in one embodiment, is reversibly adjustable relative to the support structure in a first feed direction transverse to the support direction, in one embodiment horizontal during palletizing and/or depalletizing, in order to suction a first suction side of the container or container stack transverse to the support direction.

As a result, in one embodiment, the (suctioned) container or the (suctioned) container stack can advantageously be lifted and/or tilted in the direction of an outer side of the container or container stack and thereby the blade can at least partially pass beneath, or the blade can be moved into the free space under the container (stack) resulting from the lifting or tilting. In one embodiment, the container stack suctioned by the suction device arrangement is not tilted before and/or during lifting, or is tilted by at most 30 degrees, in particular at most 15 degrees, in one embodiment at most 10 degrees. As a result, in one embodiment, the container stack can be prevented from falling apart or slipping.

Lifting is particularly advantageous with non-reusable load carriers since these often have only less(er) stability (than reusable load carriers) and—in the case of stacks with non-reusable load carriers—are not nested in one another. Accordingly, in one embodiment, the non-reusable load carriers, which are lifted by means of the suction device arrangement and/or are preferably not tilted or at most by 30 degrees, in particular at most 15 degrees, in one embodiment at most 10 degrees, are not nested within one other in the vertical direction. Advantageously, a negative pressure or vacuum can be generated on the outer side due to its surface structure and its material properties, for example cardboard or the like, which is often not the case with reusable load carriers.

By adjusting in the feed direction, in one embodiment, containers having different lengths and/or widths can advantageously be (de) palletized, and/or the first suction device can be protected.

In one embodiment, the first feed direction is parallel or transverse to the pass-beneath direction.

In one embodiment, the suction device arrangement has a second suction device which, in one embodiment, is reversibly adjustable relative to the support structure, in a second feed direction transverse to the support direction, in one embodiment horizontal during palletizing and/or depalletizing, in order to suction a section suction side of the container or container stack that is adjacent to the first suction side, in particular angled towards it, transverse to the support direction. In one embodiment, the second feed direction is transverse to the first feed direction. Additionally or alternatively, in one embodiment, the first or second feed direction is parallel or transverse to the pass-beneath direction.

In one embodiment, the container or the container stack can thereby be lifted and/or tilted very advantageously, in particular (more) securely. In one embodiment, (a suction device arrangement with a first and a second suction device for) suctioning a first or second suction side of the container or container stack can prevent (excessive) sagging of the base surface of the container (stack), which can occur if only one suction side is suctioned.

In one embodiment, first, the first suction device and only subsequently the second suction device is activated, or first, the first suction side and only subsequently the second suction side is suctioned. Additionally or alternatively, in one embodiment, the first suction side and/or second suction side are each outer sides of the container or container stack. As a result, in one embodiment, the container or the container stack can be suctioned and/or tilted or lifted very advantageously, in particular (more) securely.

Additionally or alternatively, in one embodiment, the suction device arrangement has a third suction device, which in one embodiment is reversibly adjustable relative to the support structure in the first feed direction, to suction the first suction side transverse to the support direction in addition to the first suction device if required.

In one embodiment, containers having different lengths and/or widths can thereby be advantageously (de) palletized.

Alternatively or particularly preferably in addition to the punch and/or the suction device arrangement, the gripper further has, according to one embodiment of the present invention:
a side jaw arrangement having:
   a first side jaw which is reversibly adjustable relative to the support structure in a first covering direction which, in one embodiment, is horizontal during palletizing and/or depalletizing, in order to at least partially extend over a first side surface of the container or container stack in the first covering direction; and
   a second side jaw which is reversibly adjustable relative to the support structure in a second covering direction transverse to the first covering direction, which in one embodiment is horizontal during palletizing and/or depalletizing, in order to at least partially extend over a second side surface of the container or container stack in the second covering direction, which second side surface is adjacent to the first side surface and in particular is angled towards it. In one embodiment, the second covering direction is transverse to the first covering direction. Additionally or alternatively, in one embodiment, the first or second covering direction is parallel or transverse to the pass-beneath direction.

In one embodiment, container (stacks) can thereby advantageously be (horizontally) secured during transport.

In one embodiment, the first side jaw is reversibly adjustable relative to the support structure in a first clamping direction transverse to the first covering direction and/or transverse to the support direction, in order to clamp the container or the container stack in the first clamping direction against a first support, and the second side jaw can be reversibly adjusted relative to the support structure in a second clamping direction transverse to the second covering direction and/or transverse to the support direction in order to clamp the container or the container stack in the second clamping direction against a second support which, in one embodiment, can be reversibly adjusted relative to the support structure in the second clamping direction.

In one embodiment, container stacks can thereby be very advantageously (horizontally) secured during transport.

Additionally or alternatively, this can improve, in particular facilitate and/or protect the container when pulling out the blade for or during palletizing. In one embodiment, for this purpose, the blade is first pulled out from under the container (stack) to set down the container (stack), and then the side jaws are released in the relevant clamping direction, preferably depressurized, so that the container or the container stack is still held frictionally by the side jaw arrangement when the blade is pulled out and slides down in the clamping direction after it is released.

By means of a second clamping device which is reversibly adjustable in the second clamping direction, containers having different lengths and/or widths can advantageously be (de) palletized in one embodiment.

In one embodiment, a carrier is arranged in a reversibly adjustable manner on the support structure in the pass-beneath direction.

In one embodiment, the blade is preferably arranged on this carrier, reversibly adjustable relative to the carrier in the pass-beneath direction. Additionally or alternatively, in one embodiment, the second carrier is arranged on this carrier, in one development fixed relative to the carrier, or reversibly adjustable in the second clamping direction. Additionally or alternatively, in one embodiment, the second punch is arranged on this carrier reversibly adjustable in the support direction. Additionally or alternatively, in one embodiment, the second suction device is arranged on this carrier, preferably reversibly adjustable relative to the carrier in the second feed direction.

In one embodiment, containers with different lengths and/or widths can thereby be (de) palletized very advantageously, or the gripper can be adapted to containers with different lengths and/or widths.

In one embodiment, the gripper has one or more, preferably electric, in particular electromotive, pneumatic and/or hydraulic drives which adjust the blade, the punch arrangement, in particular the first and/or second punch, the suction device arrangement, in particular the first and/or second and/or third suction device, the side jaw arrangement, in particular the first and/or second side jaw, and/or the second support, or are configured for this purpose. Different elements, in particular punches, suction devices, side jaws, and supports can be adjusted by means of the same or different types of drives.

In one embodiment, a gripper described herein is attached, in one embodiment detachably, to a robot, in particular its end flange, or is configured for this purpose, in one embodiment has a corresponding connecting flange, preferably on its support structure. As described elsewhere, a connecting surface, in one embodiment a connecting surface of the connecting flange, which is attached to the robot or to which the robot is attached or which is provided, in particular configured or used for this purpose, is a lateral or particularly preferably top-mounted connecting surface. In one embodiment, the robot has a multi-jointed or multi-axis robot arm on which, in particular on its end flange, the gripper is arranged in one embodiment.

According to one embodiment of the present invention, a method for depalletizing containers, in one embodiment for preferably alternately depalletizing containers having different lengths and/or widths and/or containers having different load carriers, in particular containers having reusable load carriers and/or containers having non-reusable load carriers, by means of a robotic system described herein, has the step of:
approaching a depalletizing position, in one embodiment on a (source) container carrier, in particular a (source) pallet, or a (source) conveying means or a (source) storage location, with the preferably unloaded gripper.

In the present case, palletizing is generally understood to mean in particular the depositing of containers, in particular container stacks, on container carriers, in particular target pallets, or conveying means or storage locations, in one embodiment based on a picking order, while depalletizing is accordingly generally understood to mean in particular the picking up of containers, in particular container stacks, from container carriers, in particular source pallets, or conveying means or storage locations, in an embodiment based on a, preferably the, picking order.

According to one embodiment of the present invention, the method for depalletizing has the steps of:
Pressing at least one side edge of at least one container, in particular container stack, counter to the support direction with the punch arrangement, in particular pressing the first side edge with the first punch, and in one embodiment, the second side edge with the second stamp; and
Tilting the gripper in the direction of an outer side of the, in particular pressed, container or container stack.

As explained elsewhere, this variant is particularly preferred in recyclable load carriers, in particular if these are nested (vertically) in one another in one development and therefore have a high stability.

According to one embodiment of the present invention, the method for depalletizing has the steps of:
Suctioning at least one suction side of at least one container, in particular container stack, with the suction device arrangement transverse to the support direction, in particular suctioning the first suction side with the first suction device transverse to the support direction and, in one embodiment, particularly preferably subsequently, suctioning the second suction side with the second suction device transverse to the support direction, wherein in one embodiment, the first suction side is additionally also suctioned with the third suction device, in particular in the case of containers with a longer first suction side, wherein in one embodiment in the case of containers with a first suction side which is shorter in comparison, the first suction side is not suctioned with the third suction device; and
Tilting the gripper toward an outer side of the container or container stack and/or lifting the gripper, in particular when the container (stack) is suctioned. In one embodiment, after activating the suction arrangement, the gripper is not tilted or is tilted by at most 30 degrees, in particular by at most 15 degrees, in one embodiment by at most 10 degrees, at least until the blade has at least partially passed under the suctioned and lifted container or container stack. In one embodiment, the risk of the container stack slipping or falling apart can thereby be reduced.

As explained elsewhere, this variant is particularly preferred in non-recyclable load carriers, especially if their suction side(s) have a surface that is advantageous for suctioning.

In one embodiment, the punch arrangement is used to press down and tilt, or the suction arrangement is used to suction and tilt and/or lift, optionally or as required, in particular depending on the container and/or alternately, i.e., in particular when depalletizing a container or container stack, in particular with first, in one embodiment recyclable load carriers, its side edge or side edges are pressed and, during a subsequent depalletizing of a further container or container stack, in particular with second, in one embodiment non-recyclable load carriers, its outer side(s) is/are suctioned, and/or vice versa, when depalletizing a container or container stack, in particular with second, in one embodiment non-recyclable load carriers, its outer side(s) are suctioned and, during a subsequent depalletizing of a further container or container stack, in particular with the first, in one embodiment recyclable, load carriers, its side edge(s) are pressed.

According to one embodiment of the present invention, the method for depalletizing has the steps of:
at least partially passing the blade beneath the lifted or tilted container or container stack in the pass-beneath direction, in particular after pressing or suctioning and subsequently lifting or tilting, and
carrying away the container or container stack with the gripper.
   In one embodiment, the container or the container stack or the depalletizing position is approached from an outer corner of the container or container stack.

As a result, in one embodiment, containers (stacks), in one embodiment successively or alternately containers (stacks) with different lengths and/or widths, and/or both with reusable load carriers and with non-reusable load carriers, can advantageously be automatically depalletized, in particular gently, reliably and/or quickly.

In one embodiment, after the gripper has been lifted or tilted, in particular after the blade has at least partially passed under the container or container stack in the pass-beneath direction, and/or before the container or container stack has been transported away, the first side jaw is adjusted in the first covering direction in order to at least partially extend over the first side surface of the container or container stack, and the second side jaw is adjusted in the second covering direction in order to at least partially extend over the second side surface of the container or container stack.

Additionally or alternatively, in one embodiment, the first side jaw, in particular the first side jaw at least partially extending over the first side surface, is adjusted in the first clamping direction in order to clamp the container or the container stack in the first clamping direction against the first support, and the second side jaw, in particular the second side jaw at least partially extending over the second side surface is adjusted in the second clamping direction transverse to the second covering direction in order to clamp the container or the container stack against the second support in the second clamping direction.

In one embodiment, containers (stacks) can thereby advantageously be (horizontally) secured during transport.

According to one embodiment of the present invention, a method for palletizing containers, in one embodiment for, preferably alternately, palletizing containers having different lengths and/or widths, and/or containers with reusable load carriers, and/or containers with non-reusable load carriers, has the steps by a robot system described here:
Approaching a palletizing position, in particular on a (target) container carrier, in particular a (target) carrier, or a (target) conveying means or a (target) storage location, with the gripper loaded with at least one container, in particular the container stack;
Pulling the blade counter to the pass-beneath direction under the container or container stack; and
Withdrawing the gripper.

In one embodiment, after the blade is pulled out and before the gripper is withdrawn, the first side jaw is relaxed, preferably depressurized, in the first clamping direction and the second side jaw in the second clamping direction, and/or spaced apart from the container or container stack in order to set down the container or the container stack against the support direction.

In one embodiment, this can improve the setting down, in particular the blade and/or container can be protected, and/or precision, reliability and/or speed can be increased.

In one embodiment, preferably after this relaxation, the first side jaw is adjusted counter to the first covering direction and the second side jaw counter to the second covering direction, in one embodiment such that it no longer (at least partially) covers the container or the container stack.

In one embodiment, the withdrawal, in particular a lateral withdrawal, of the gripper can thereby be improved.

According to one embodiment of the present invention, a method for (depalletizing and) palletizing containers, in particular containers with different lengths and/or widths, and/or containers with reusable load carriers and/or containers with non-reusable load carriers, has a depalletization described herein, and a palletization described herein immediately following in one embodiment.

In one embodiment, the gripper, before approaching the palletizing position with at least one container, in particular a container stack, is loaded with this container (stack) by depalletizing as described here, wherein in one embodiment, the gripper palletizes this container or this container stack directly or immediately at the palletizing position, preferably onto the (target) container carrier or the (target) conveying means or the (target) storage location, after this depalletizing without intermediate unloading.

Thus, in one embodiment, intermediate storage of the containers is dispensed with; in one development, containers are transferred directly from one or more source conveying means or source storage locations, or particularly preferably from one or more source container carriers, to one or more target conveying means or target storage locations, or particularly preferably to one or more target container carriers, in particular on the basis of a predetermined order picking, preferably order picking sequence, and/or in container stacks, preferably as high as possible.

In one embodiment, order picking can thereby be accelerated, which is particularly important or advantageous in the case of fresh goods or non-preserved foods, preferably fresh fruit and/or fresh vegetables. In general, in one embodiment, the container or the container stack has fresh goods, preferably fresh fruit and/or fresh vegetables, without the invention being limited thereto.

Additionally or alternatively, in one embodiment, before the palletizing position is approached, the gripper is loaded with the container, in particular the container stack, at a pick-up location, which allows the blade to pass below the container without the lifting described here and without the tilting described here, instead of being loaded by depalletizing according to a method described here. In one embodiment, the loading can thereby be accelerated.

In one embodiment, the target container carrier is transported, in particular by a conveying means or particularly preferably a driverless transport vehicle, after a palletizing described herein of at least one container, in particular a container stack, to a further robot where, preferably in the manner described herein, at least one further container, in particular a further container stack, is palletized onto this target container carrier by the further robot. Additionally or alternatively, in one embodiment, the source container carrier can also be transported, in particular by a conveyor means or particularly preferably a driverless transport vehicle, after depalletizing at least one container, in particular a container stack, in the manner described herein to a further robot where, preferably in the manner described herein, at least one further container, in particular a further container stack, is depalletized from this source container carrier by the further robot.

In one embodiment, the flexibility and/or speed of order picking that comprises depalletizing and palletizing can thereby be increased.

In one embodiment, the second support is adjusted in the second clamping direction in order to adapt the gripper to different containers with different lengths and/or widths, in particular after setting down a container (stack) and before picking up a new container (stack) with a different length and/or width.

Different containers can thereby be advantageously (de) palletized or picked.

In one embodiment, the first suction device and/or the second suction device and/or the third suction device has (in each case) multiple suction openings, in particular, in one embodiment spaced apart and/or separately (designed) and/or fluidically connected, suction nozzles or the like.

In one embodiment, containers can thereby be protected and/or safety can be increased.

In one embodiment, one or more suction openings of the suction device arrangement, in particular one or more suction openings of the first suction device and/or one or more suction openings of the second suction device and/or one or more suction openings of the third suction device, are deactivated, in one embodiment as a result of detecting a missing active surface.

This means that, in one embodiment, containers or container stacks of different heights, different lengths and/or different widths can advantageously be suctioned.

In one embodiment, the blade is reversibly adjustable relative to the support structure in the support direction, and/or is adjusted in the support direction after lifting or tilting gripper when the container (stack) is pressed or suctioned and/or before carrying away the container or container stack, in particular before the first side jaw is adjusted in the first covering direction, in order to at least partially extend over the first side surface of the container or container stack, and the second side jaw is adjusted in the second covering direction in order to at least partially extend over the second side surface of the container or container stack.

As a result, in one embodiment, a further lifting or tilting of the container or container stack can be supported, and/or the effect of the punch and/or suction device arrangement can be supported, or it can be relieved.

In one embodiment, after the blade at least partially passes beneath the container or container stack and/or the blade is adjusted in the support direction, it is further lifted and/or tilted and/or distanced from the depalletizing position transverse to the support direction before the side jaws at least partially extend over the side surfaces, as a result of which, in one embodiment, the suction device arrangement is advantageously supported or relieved, and/or the adjustment of the side jaws is facilitated.

In one embodiment, an angle between two directions which are transverse to one another is at least 45 degrees and/or at most 135 degrees, in particular at least 60 degrees and/or at most 120 degrees, in one embodiment at least 75 degrees and/or at most 105 degrees, preferably at least 85 degrees and/or at most 95 degrees. In this case, different angles can exist between two directions which are transverse to one another, and between two other directions, which are also transverse to one another. Additionally or alternatively, in one embodiment, an angle between two side edges angled toward each other, and/or between two side surfaces angled toward each other, and/or between two suction sides angled toward each other is at least 45 degrees and/or at most 135 degrees, in particular at least 60 degrees and/or at most 120 degrees, in one embodiment at least 75 degrees and/or at most 105 degrees, preferably at least 85 degrees and/or at most 95 degrees. The angles can, on the other hand, be different.

In one embodiment, an outer side of the container or container stack is a free side, preferably a longitudinal or wide side, wherein one or more further containers or container stacks can each be arranged or present on a side opposite these outer sides. Accordingly, in one embodiment during depalletizing, an outer or free corner of the container or container stack is approached, and preferably the two side surfaces of the container or container stack not adjacent to this corner are at least partially overlapped by the side jaw arrangement during depalletizing and thus secured, in particular horizontally. Additionally or alternatively, in one embodiment during palletizing, a free space is approached from an outer or free corner of this space or an outer or free corner of this space is approached, wherein preferably the two side surfaces of the container or container stack not adjacent to this corner are initially at least partially overlapped by the side jaw arrangement and are thus secured, in particular horizontally.

In one embodiment, one or more, in particular all, steps of the method are performed completely or partially automatically, in particular by the robot system.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a part of a robot system with a gripper according to one embodiment of the present disclosure in a vertical plan view;

FIG. 2 depicts the part of the robot system with the gripper in a horizontal side view;

FIGS. 3A-3E illustrate a depalletization according to one embodiment of the present disclosure;

FIGS. 4A-4F illustrate a depalletization according to one embodiment of the present disclosure; and

FIGS. 5A-5D illustrate a palletization according to one embodiment of the present disclosure.

### DETAILED DESCRIPTION

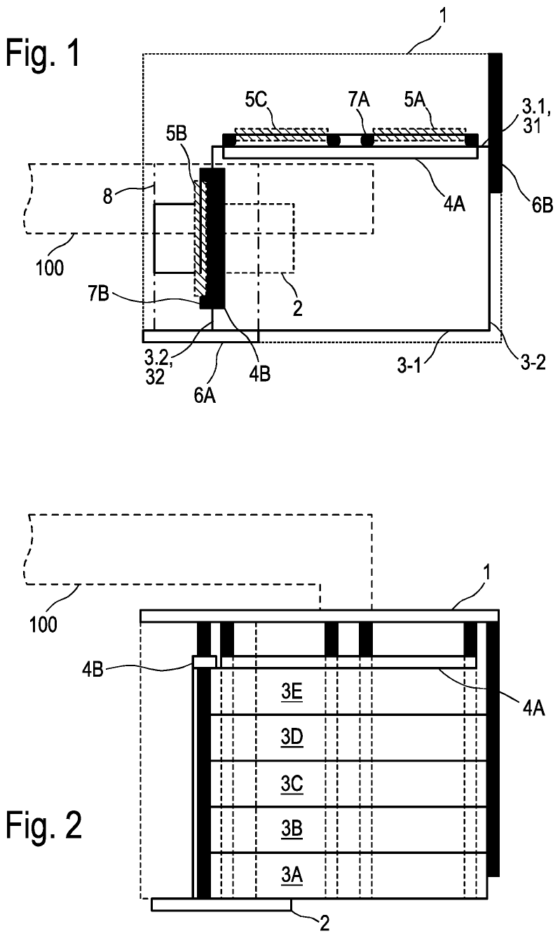

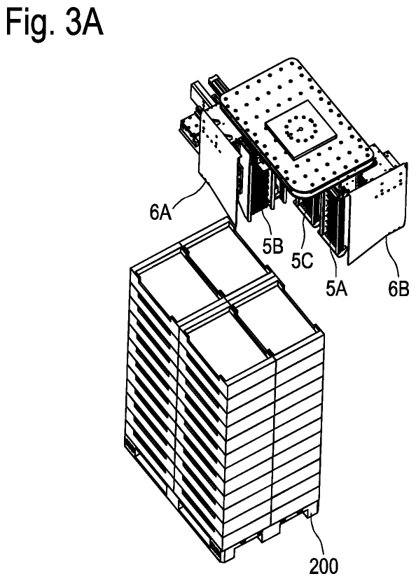

FIGS. 1, 2 show, partially schematized, a part of a robot system with a gripper according to an embodiment of the present invention in a top or side view.

The robot system has a robot (arm), of which only one end region 100 is shown in FIG. 1, 2, and the gripper arranged thereon.

The gripper has an upper support structure 1 which is indicated only by dashed lines in FIG. 1, and a blade 2 which is reversibly adjustable relative to the support structure in a horizontal pass-beneath direction (horizontal in FIGS. 1, 2) in order to support a container or a container stack 3A-3E in a vertical support direction (vertical in FIG. 2) transverse to the pass-beneath direction.

In a modification (not shown), the support structure 1 can have a lateral region in addition or alternative to the top region shown in FIGS. 1, 2, and/or can be attached to the robot or its end region 100 with or on a lateral connection surface instead of with or on a top connection surface (top side of the support structure 1 in FIG. 2).

The gripper further has a punch arrangement with a first punch 4A, which is reversibly adjustable in the support direction, in order to press a first side edge 3.1 of the container (stack) counter to the support direction, i.e., vertically downward, and a second punch 4B, which is reversibly adjustable in the support direction, in order to press a second side edge 3.2 of the container (stack) adjacent to the first side edge and angled toward it, counter to the support direction, i.e., vertically downward.

The gripper further has a suction device arrangement having a first suction device 5A which is reversibly adjustable in a first feed direction (vertical in FIG. 1) transverse to the support direction, in order to suction a first suction side 31 of the container (stack) transverse to the support direction (vertically upward in FIG. 1), and a second suction device 5B, which is reversibly adjustable in a second feed direction (horizontally in FIG. 1) transverse to the support direction, in order to suction a second suction side 32 of the container (stack) adjacent to the first suction side and angled toward it (horizontally to the left in FIG. 1), and a third suction device 5C reversibly adjustable in the first feed direction, to suction the first suction side in addition to the first suction device if required.

The gripper further has a side jaw arrangement with a first side jaw 6A, which is reversibly adjustable relative to the support structure in a first covering direction (horizontal in FIG. 1) in order to at least partially extend over a first side surface 3-1 of the container (stack) in the first covering direction, and a second side jaw 6B which is reversibly adjustable relative to the support structure in a second covering direction (vertical in FIG. 1) transverse to the first covering direction in order to extend over a second side surface 3-2 of the container (stack) adjacent to the first side surface and angled toward it, in the second covering direction.

The first side jaw 6A is reversibly adjustable relative to the support structure in a first clamping direction (vertical in FIG. 1) transverse to the first covering direction in order to clamp the container stack in the first clamping direction against a first support 7A, and the second side jaw 6B is reversibly adjustable relative to the support structure in a second clamping direction (horizontally in FIG. 1) transverse to the second covering direction in order to clamp the container stack in the second clamping direction against a second support 7B that is reversibly adjustable in the second clamping direction.

For a clearer illustration, the drives and guides for realizing the adjustments described herein are not shown in FIGS. 1 and 2. In FIGS. 1, 8 schematically indicates a carrier with a dotted line, on which the blade 2 (reversibly adjustable in the pass-beneath direction), the second suction device 5B (reversibly adjustable in the second feed direction) and the second support 7B are arranged, which in turn is reversibly adjustable relative to the support structure 1 in the second clamping direction. In a modification, this carrier 8 can also be omitted and the blade 2, second suction device 5B and second support 7B can be connected directly to the structure 1 or can be adjusted relative thereto.

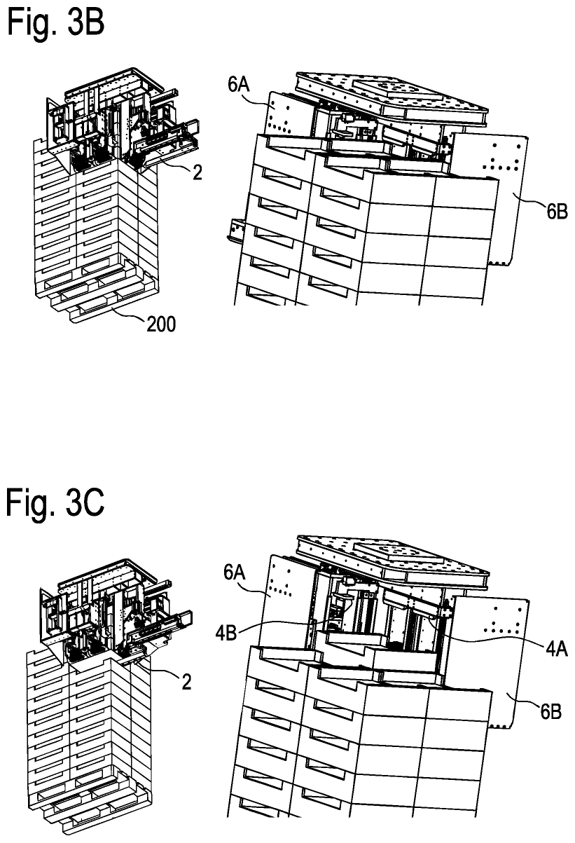

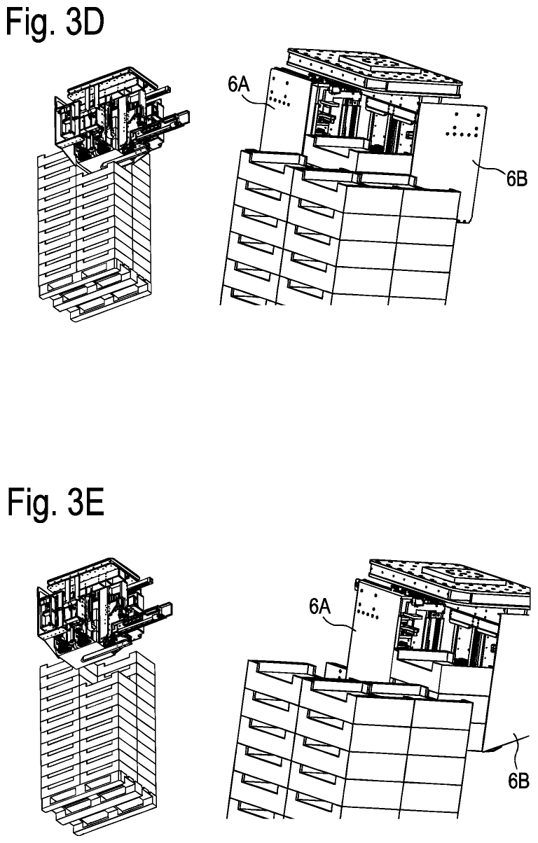

FIGS. 3A-3E show a depalletization according to one embodiment of the present invention.

First, with the unloaded gripper, a depalletizing position is approached on a (source) container carrier 200 (FIG. 3A to FIG. 3B). The side jaws 6A, 6B, the blade 2 and the three suction devices 5A-5C are retracted and the punches 4A, 4B are pulled up.

The suction devices 5A, 5C are then first advanced toward the container stack in the first feed direction, and their suction openings are activated, and then the suction device 5B is advanced in the second feed direction toward the container stack, and its suction openings are activated. Suction openings which do not find an effective surface are deactivated (FIG. 3B).

The gripper is now lifted, and then the blade 2 partially passes beneath the container stack in the pass-beneath direction (FIG. 3B to FIG. 3C). Subsequently, the blade 2 is adjusted in the support direction, the gripper is lifted further and distanced from the depalletizing position transverse to the support direction, the first side jaw 6A is adjusted in the first covering direction in order to at least partially extend over the first side surface of the container stack, the second side jaw 6B is adjusted in the second covering direction in order to at least partially extend over the second side surface of the container stack, the first side jaw is adjusted in the first clamping direction in order to clamp the container stack in the first clamping direction against the first support, and the second side jaw is adjusted in the second clamping direction transverse to the second covering direction to clamp the container stack in the second clamping direction against the second support (FIG. 3C to FIG. 3E).

The suction devices 5A-5C (see FIG. 1) are then deactivated, and the stack is transported away with the gripper (FIG. 3D to FIG. 3C).

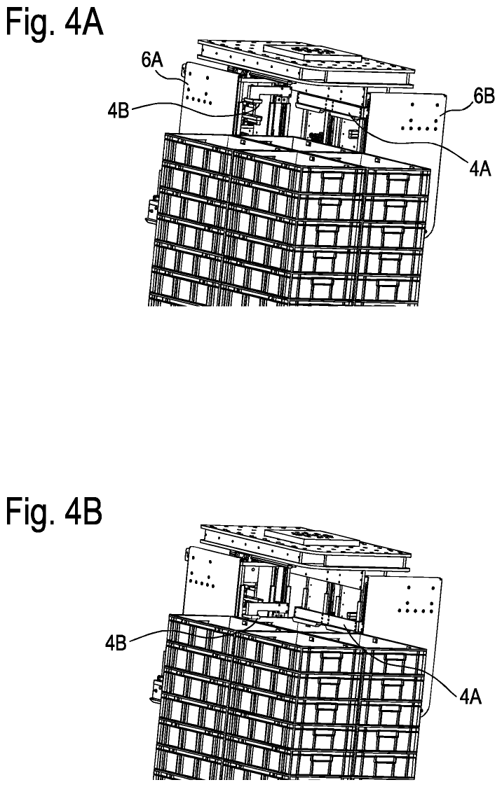

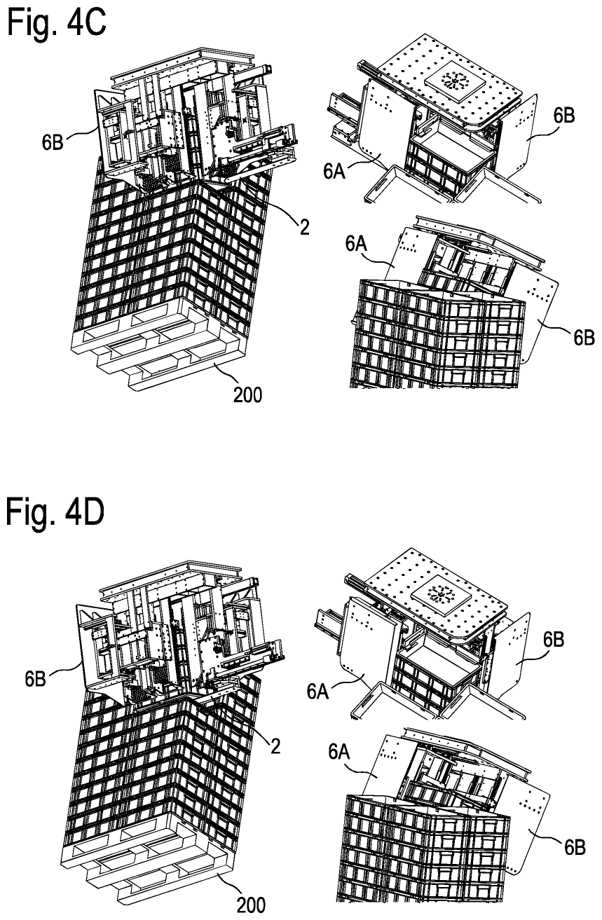

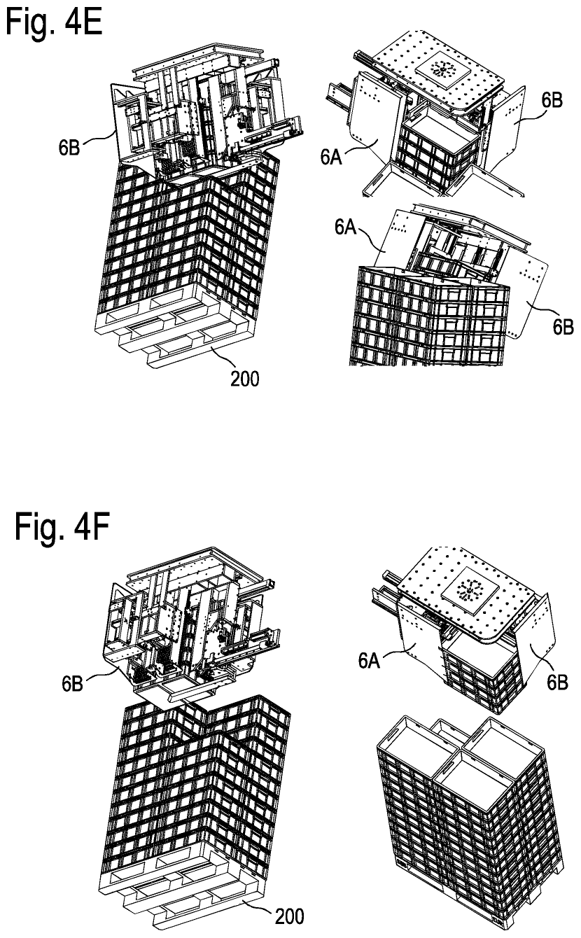

FIG. 4A-4F also show a depalletization according to one embodiment of the present invention.

First, with the unloaded gripper, a depalletizing position is approached on a (source) container carrier 200. In this case, the side jaws 6A, 6B are retracted counter to their corresponding covering direction, the blade 2 counter to its pass-beneath direction, and the three suction devices 5A-5C are retracted counter to their feed direction, and the punches 4A, 4B are pulled up in the support direction.

The punches 4A, 4B are then adjusted or lowered toward the container stack counter to the support direction (FIG. 4A to FIG. 4B) in order to press the first and second side edges of the container stack with the punch arrangement counter to the support direction.

The gripper is then tilted in the direction of an outer side of the container stack (FIG. 4B to FIG. 4C), and then the blade 2 partially passes beneath the container stack which is optionally adjusted in the support direction, and the side jaws 6A, 6B are opened against their corresponding clamping direction (FIG. 4C to FIG. 4D).

The gripper is then lifted and removed from the depalletizing position transverse to the support direction (FIG. 4D to FIG. 4E), the first side jaw 6A is adjusted in the first covering direction in order to at least partially extend over the first side surface of the container stack, the second side jaw 6B is adjusted in the second covering direction in order to at least partially extend over the second side surface of the container stack, the first side jaw is adjusted in the first clamping direction in order to clamp the container stack in the first clamping direction against the first support, and the second side jaw is adjusted in the second clamping direction transverse to the second covering direction to clamp the container stack in the second clamping direction against the second support, and the container stack is transported away with the gripper (FIG. 4E to FIG. 4F).

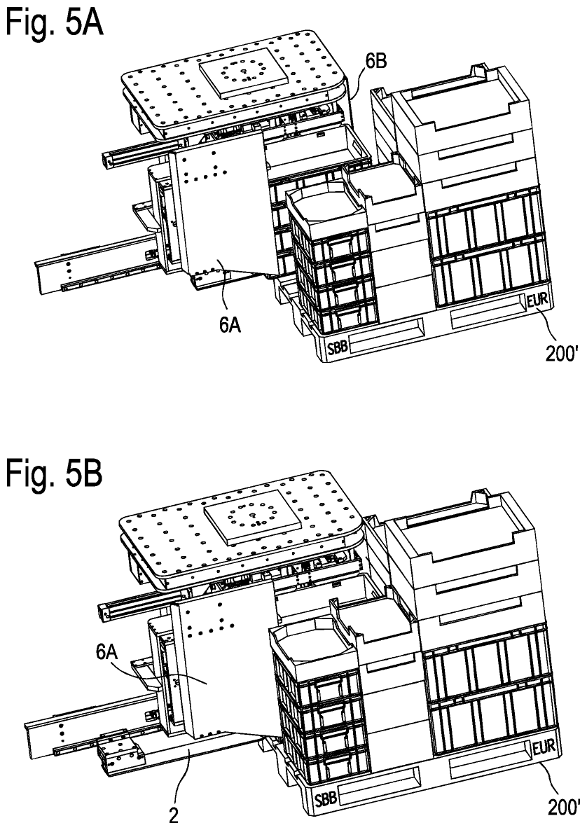

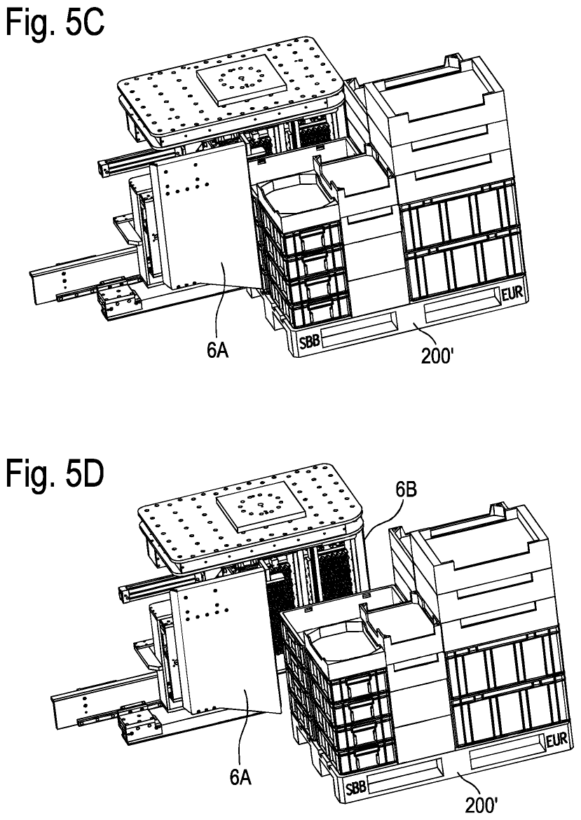

FIGS. 5A-5D show a palletization according to one embodiment of the present invention, which preferably directly follows the depalletization of FIGS. 3A-3E or 4A-4F.

First, a palletizing position on a (target) container carrier 200′ is approached with the gripper loaded with a container stack. The blade 2 is then pulled out from under the container stack counter to the pass-beneath direction (FIG. 5A to FIG. 5B).

The first side jaw 6A is now relaxed in the first clamping direction and the second side jaw 6B in the second clamping direction in order to deposit the container stack against the support direction, and then retracted counter to their covering direction (FIG. 5B to FIG. 5C).

The gripper is then moved away (FIG. 5C to FIG. 5D).

Although embodiments have been explained in the preceding description, it is noted that a large number of modifications are possible. It is also noted that the embodiments are merely examples that are not intended to restrict the scope of protection, the applications, and the structure in any way. Rather, the preceding description provides a person skilled in the art with guidelines for implementing at least one embodiment, various changes—in particular with regard to the function and arrangement of the described components-being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Support structure
2 Blade
3A-3E Container stack
3.1/3.2 First/second side edge
31/32 First/second suction side
3-1/3-2 First/second side surface
4A/4B First/second stamp
5A/5B/5C First/second/third suction device
6A/6B First/second side jaw
7A/7B First/second support
8 Carrier
100 Robot
200; 200′ Container carrier

What is claimed is:

1-15. (canceled)

16. A gripper for palletizing and/or depalletizing containers using a robot, the gripper comprising:
a support structure;
a blade that is reversibly adjustable relative to the support structure in a pass-beneath direction in order to support at least one container in a support direction transverse to the pass-beneath direction; and
at least one of:
a) a punch arrangement having a first punch which is reversibly adjustable relative to the support structure in the support direction in order to push a first side edge of the at least one container counter to the support direction,
b) a suction device arrangement having a first suction device which is reversibly adjustable in a first feed direction transverse to the support direction, and configured to suction a first suction side of the at least one container in a direction transverse to the support direction, or
c) a side jaw arrangement, comprising:
a first side jaw which is reversibly adjustable relative to the support structure in a first covering direction in order to at least partially extend over a first side surface of the at least one container in the first covering direction, and
a second side jaw which is reversibly adjustable relative to the support structure in a second covering direction transverse to the first covering direction in order to at least partially extend over a second side surface of the at least one container adjacent to the first side surface in the second covering direction.

17. The gripper of claim 16, wherein at least one of:
the support structure comprises at least one of an upper support structure or lateral support structure;
the gripper is configured to palletize and/or depalletize a plurality of containers arranged in a container stack; or
the first suction device is reversibly adjustable relative to the support structure in the first feed direction.

18. The gripper of claim 16, wherein:
the first side jaw is reversibly adjustable relative to the support structure in a first clamping direction transverse to at least one of the support direction or the first covering direction in order to clamp the at least one container in the first clamping direction against a first support; and
the second side jaw is reversibly adjustable relative to the support structure in a second clamping direction transverse to at least one of the support direction or the second covering direction in order to clamp the at least one container in the second clamping direction against a second support, which is reversibly adjustable in the second clamping direction.

19. The gripper of claim 18, wherein the second support is reversibly adjustable relative to the support structure in the second clamping direction.

20. The gripper of claim 16, wherein at least one of:
the blade is reversibly adjustable relative to the support structure in the support direction;
the punch arrangement has a second punch which is reversibly adjustable relative to the support structure in the support direction in order to press a second side edge of the at least one container adjacent to the first side edge counter to the support direction; or
the suction device arrangement further comprises at least one of:
a second suction device configured to suction a second suction side of the at least one container adjacent to the first suction side in a direction transverse to the support direction, or
a third suction device configured to cooperate with the first suction device to suction the first suction side of the at least one container.

21. The gripper of claim 20, wherein at least one of:
the second suction device is reversibly adjustable relative to the support structure in a second feed direction transverse to the support direction in order to suction the second suction side of the at least one container; or
the third suction device is reversibly adjustable relative to the support structure in the first feed direction in order to suction the first suction side.

22. A robot system, comprising:
a robotic manipulator; and
a gripper for palletizing and/or depalletizing containers according to claim 16, the gripper arranged on the robot.

23. A method for depalletizing containers, using a robot system, the method comprising:
obtaining a robot system of claim 22;
approaching a depalletizing position with the gripper;
at least one of:
pressing at least one side edge of at least one container in a direction counter to the support direction with the punch arrangement, or
suctioning at least one suction side of at least one container with the suction device arrangement in a direction transverse to the support direction;
at least one of tilting the gripper toward an outer side of the at least one container or lifting the gripper;
at least partially passing the blade beneath the at least one container in the pass-beneath direction; and
transporting away the at least one container with the gripper.

24. The method of claim 23, wherein at least one of:
the at least one container comprises at least one of:
a plurality of individual containers in a stacked arrangement,
a plurality of containers having different lengths and/or widths,
containers with reusable load carriers, or
containers with non-reusable load carriers;
approaching the depalletizing position comprises approaching the depalletizing position on one of a container carrier, a conveying means, or a storage location;
approaching the depalletizing position with the gripper comprises approaching the depalletizing position with the gripper in an unloaded condition; or
passing the blade beneath the at least one container comprises passing the blade beneath a stack of containers.

25. The method of claim 23, wherein, after lifting or tilting the gripper, the method further comprises at least one of:
adjusting the blade in the support direction; or
adjusting the first side jaw in the first covering direction in order to at least partially extend over the first side surface of the container or container stack, and adjusting the second side jaw in the second covering direction in order to at least partially extend over the second side surface of the container or container stack.

26. The method of claim 25, wherein adjusting the blade in the support direction or adjusting the first and second side jaws in the respective covering directions is performed at least one of:
after the blade has at least partially passed beneath the at least one container in the pass-beneath direction; or
before the at least one container has been transported away.

27. The method of claim 23, further comprising:
adjusting the first side jaw in the first clamping direction in order to clamp the at least one container in the first clamping direction against the first support; and
adjusting the second side jaw in the second clamping direction transverse to the second covering direction in order to clamp the at least one container in the second clamping direction against the second support.

28. A method for depalletizing containers with first load carriers and containers with second load carriers, the method comprising:
obtaining a robot system of claim 22;
depalletizing with the gripper at least one first container with a first load carrier, wherein the depalletizing comprises:
approaching a depalletizing position with the gripper,
pressing at least one side edge of at least one first container in a direction counter to the support direction with the punch arrangement,
tilting the gripper in the direction of an outer side of the at least one first container,
at least partially passing the blade beneath the at least one first container in the pass-beneath direction, and
transporting away the at least one first container with the gripper; and
depalletizing with the gripper at least one second container with a second load carrier, wherein the depalletizing comprises:
approaching a depalletizing position with the gripper,
suctioning at least one suction side of at least one second container with the suction device arrangement in a direction transverse to the support direction,
at least one of tilting the gripper toward an outer side of the at least one second container or lifting the gripper,
at least partially passing the blade beneath the at least one second container in the pass-beneath direction, and
transporting away the at least one second container with the gripper.

29. The method of claim 28, wherein the first load carrier is a reusable load carrier, and the second load carrier is a non-reusable load carrier.

30. A method for palletizing containers using a robot system, the method comprising:
obtaining a robot system of claim 22;
approaching a palletizing position with the gripper loaded with at least one container;
pulling the blade in a direction counter to the pass-beneath direction under the at least one container; and
withdrawing the gripper.

31. The method of claim 30, wherein at least one of:
the at least one container comprises at least one of:
a plurality of individual containers in a stacked arrangement,
a plurality of containers having different lengths and/or widths,
containers with reusable load carriers, or
containers with non-reusable load carriers;
approaching the depalletizing position comprises approaching the depalletizing position on one of a container carrier, a conveying means, or a storage location;
pulling the blade under the at least one container comprises pulling the blade under a stack of containers;
after pulling the blade and before withdrawing the gripper, the method further comprises at least one of:
relaxing the first side jaw in the first clamping direction and relaxing the second side jaw in the second clamping direction in order to deposit the at least one container against the support direction, or
adjusting the first side jaw in a direction counter to the first covering direction, and adjusting the second side jaw in a direction counter to the second covering direction; or
the method further comprises:
depalletizing at least one first container before approaching the palletizing position in order to load the gripper with at least one second container, or
after depalletizing at least one container at a collection point that enables the blade to pass under the at least one container without lifting and without tipping, subsequently palletizing the at least one container that was depalletized, without intermediate unloading of the at least one container at the palletizing position.

32. The method of claim 31, wherein depalletizing the at least one container comprises:
approaching a depalletizing position with the gripper,
performing either:
a) pressing at least one side edge of at least one container in a direction counter to the support direction with the punch arrangement, or
b) suctioning at least one suction side of at least one container with the suction device arrangement in a direction transverse to the support direction;
tilting the gripper in the direction of an outer side of the at least one container or lifting the gripper;
at least partially passing the blade beneath the at least one container in the pass-beneath direction; and
transporting away the at least one container with the gripper.

33. The method of claim 23, further comprising:
adjusting the second support in the second clamping direction in order to adapt the gripper to different containers having different lengths and/or widths.

34. The method of claim 23, further comprising:
deactivating one or more suction openings of the suction device arrangement, in response to a detection of a missing active surface.
